(19) United States
(12) Patent Application Publication
(10) Pub. No.: US 2013/0250171 A1
(43) Pub. Date: Sep. 26, 2013

(54) METHOD AND APPARATUS FOR INTERRUPTING HDMI CEC BROADCAST MESSAGES

(71) Applicants: Scott Russell Francis, Danville, CA (US); Gregory Charles Herlein, San Francisco, CA (US)

(72) Inventors: Scott Russell Francis, Danville, CA (US); Gregory Charles Herlein, San Francisco, CA (US)

(73) Assignee: THOMSON LICENSING, Issy des Moulineaux (FR)

(21) Appl. No.: 13/991,045

(22) PCT Filed: Sep. 8, 2011
(86) PCT No.: PCT/US2011/050749

§ 371 Date: May 31, 2013

Related U.S. Application Data
(60) Provisional application No. 61/421,397, filed on Dec. 9, 2010.

(51) Int. Cl. H04N 7/088

(52) U.S. Cl. CPC H04N 7/088
USPC 348/461; 307/112

(57) ABSTRACT

A method and means for selectively interrupting HDMI CEC broadcast messages include the electrical connection of the connectors of a male HDMI connector with respective connections of a female HDMI connector to form a pass through connector with the exception of a CEC line, which is disconnected. The method and means are such that the CEC line can be controllably connected and disconnected via, for example, a controllable circuit board. The circuit board can be programmed to block selected CEC commands by controllably connecting and disconnecting a respective CEC line in response to a CEC command.

### CROSS-REFERENCE TO RELATED APPLICATIONS

This patent application claims the benefit of and/or priority to U.S. provisional patent application Ser. No. 61/421,397 filed Dec. 9, 2010, the entire contents of which is specifically incorporated herein by reference.

### FIELD OF THE INVENTION

The present invention generally relates to High Definition Multimedia Interface (HDMI) communication and, more particularly, to a method and apparatus for interrupting HDMI Consumer Electronics Control (CEC) broadcast messages.

### BACKGROUND OF THE INVENTION

HDMI is a digital video and audio connection system used to connect a variety of audio/video components, particularly high-definition video (HDTV). HDMI supports all HDTV formats (720p, 1080i, 1080p) along with support for up to eight channels of digital audio.

In typical retail store merchandising televisions, retailers are starting to use

HDMI distribution switching equipment to take the audio and video signal from one source and distribute it to many televisions in the store. However, using a remote control for one TV to send a ‘standby’ command, for example, will have the adverse effect of placing many of the TVs in the store in ‘standby’ (off) mode. This happens because according to HDMI 1.3a specification section CEC 13.3 the ‘System Standby’ message may be broadcast to place a whole system in standby. A device may directly send a message to a specific address if desired, but this behavior is specifically called out as manufacturer dependent. Section 8.7.1 states that the “CEC line is directly connected to all nodes on the network.” Thus, using the remote for one TV to place the TV in standby may cause all the TVs in the store that support ‘standby’ behavior across the CEC line to turn off. This behavior adversely affects shoppers and can result in extra costs to the retailers, as well as potential loss of sales of televisions and a loss of advertising impressions if those screens were supposed to be displaying paid advertisements.

The only known solution at this point is to go to all the TVs in the store that you do not want to go into ‘standby’ and manually configure them to ignore CEC commands. This manual effort is costly and unreliable since it must be performed for every TV placed onto a display area.

### SUMMARY OF THE INVENTION

Embodiments of the present invention address the deficiencies of the prior art by providing a method and apparatus for providing a selective means to interrupt HDMI CEC broadcast messages (and optionally vendor specific messages) so as to not adversely affect the viewing status of other displays on the HDMI communication line that are not intended to receive the broadcast messages.

In one embodiment of the present invention, a method for selectively interrupting high definition multimedia interface (HDMI) consumer electronics control (CEC) broadcast messages includes identifying at least one CEC line for which communication is to be interrupted and inserting, between a source of an HDMI CEC broadcast message and a receiver with which said at least one CEC line to be interrupted is in communication, a CEC line interrupter.

In one embodiment of the present invention, a CEC line interrupter includes a male HDMI connector and a female HDMI connector, where connections of the male HDMI connector are in electrical communication with respective connections of the female HDMI connector to form a pass through connector except for a CEC line of the male HDMI connector and the female HDMI connector, which are not connected.

In an alternate embodiment of the present invention, an HDMI splitter includes an HDMI input, at least two HDMI outputs and at least one means for selectively interrupting HDMI CEC broadcast messages to be communicated from the at least two HDMI outputs.

In one embodiment of the present invention, a means for selectively interrupting HDMI CEC broadcast messages includes a male HDMI connector, a female HDMI connector and a circuit board for controllably connecting and disconnecting the CEC line of the male HDMI connector and the female HDMI connector.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a prior art system in which a media player is connected to a plurality of displays via an HDMI splitter/switch and using HDMI communication;

FIG. 2 depicts a high level block diagram of a system, similar to the system of FIG. 1, in which a media player is connected to a plurality of displays via an HDMI splitter/switch and using HDMI communication including an embodiment of a CEC line interrupter in accordance with an embodiment of the present invention;

FIG. 3 depicts a high level block diagram of a system, similar to the system of FIG. 2, in which a media player is connected to a plurality of displays via an HDMI splitter/switch and using HDMI communication including an alternate embodiment of a CEC line interrupter in accordance with an alternate embodiment of the present invention;

FIG. 4 depicts a high level block diagram of a system in which a media player is connected to a plurality of displays via an HDMI splitter/switch and using HDMI communication including an alternate embodiment of a CEC line interrupter in accordance with an alternate embodiment of the present invention;

FIG. 5 depicts a high level block diagram of a CEC line interrupter in accordance with an embodiment of the present invention; and

FIG. 6 depicts a high level block diagram of a CEC line interrupter in accordance with an alternate embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method and apparatus for providing a selective means to interrupt HDMI CEC broadcast messages (and optionally vendor specific messages) so as to not adversely affect the viewing status of other displays on the HDMI communication line that are not intended to receive the broadcast messages. Although the present invention will be described primarily within the context of a retail advertising network environment, the specific embodiments of the present invention should not be treated as limiting the scope of the invention. It will be appreciated by those skilled in the art and informed by the teachings of the present invention that the concepts of the present invention can be advantageously applied in any communications or network environment using HDMI communication.

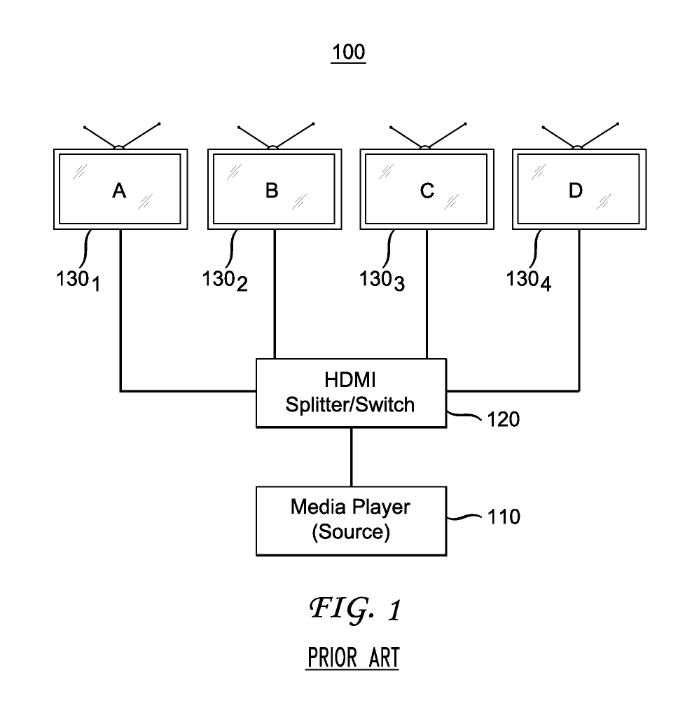

FIG. 1 depicts a high level block diagram of a prior art system in which a media player is connected to a plurality of displays via an HDMI splitter/switch and using HDMI communication. The system 100 of FIG. 1 illustratively comprises a media player 110 as a source of content, an HDMI splitter/switch 120, and four displays (A-D) 130₁-130₄. In the system 100 of FIG. 1, the HDMI splitter/switch 120 illustratively comprises four outputs and each output goes to a respective display in, for example, a retail advertising environment. In the system 100 of FIG. 1, using a remote to turn off, for example, the fourth display (D) will result in a ‘standby’ message being broadcast across the entire HDMI network via the HDMI splitter/switch 120, and as such, all other displays (A-C) on the HDMI network that support CEC will turn off.

In accordance with various embodiment of the present invention, to prevent such inadvertent control of displays supported by an HDMI system, such as the system 100 of FIG. 1, embodiments of the present invention provide a means for selectively interrupting the CEC line of the HDMI communication system to specific displays for which a broadcast message is not intended.

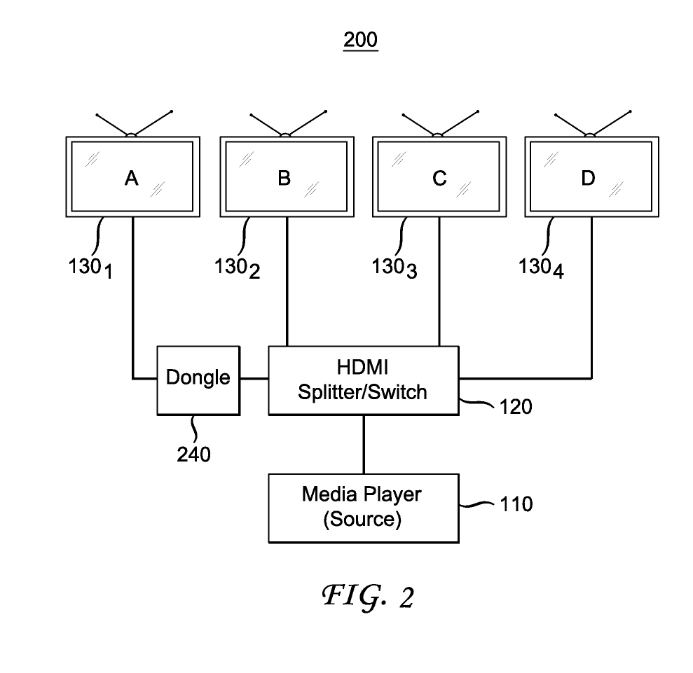

For example, FIG. 2 depicts a high level block diagram of a system, similar to the system of FIG. 1, in which a media player is connected to a plurality of displays via an HDMI splitter/switch and using HDMI communication including an embodiment of a CEC line interrupter in accordance with an embodiment of the present invention. In accordance with an embodiment of the present invention, the system 200 of FIG. 2 includes a dongle 240 that, in the embodiment of FIG. 2, includes a male and a female HDMI connector. In the embodiment of FIG. 2, all wires in the HDMI connector are passed through from Male to Female through the dongle 240 of the present invention except the CEC line. As such, and as illustrated in FIG. 2, the CEC line to the first display 130₁ (display A) is broken using the dongle 240 of the present invention. In one embodiment of the present invention, both ends of the dongle are terminated with an appropriate resistor (not shown) as if CEC was not supported at all in that HDMI line. That is, in such an embodiment, the CEC line through the dongle 240 is electrically isolated on each side in a fashion that the equipment on either side assumes that CEC is not supported by that connected device. Thus no CEC commands can go to the device such as the display 130₁ (display A).

The dongle 240 of FIG. 2 prevents CEC commands of any kind from transmitting down the cable that is plugged into the intended display, for example, the first display 130₁ (display A) of the system 200 of FIG. 2. This is a low cost alternative to manually disabling CEC functionality on the display. That is, in accordance with the embodiment of the present invention of FIG. 2, a dongle 240 can be connected in line between a content source 110 and a selected display 130 to prevent CEC commands of any kind from transmitting down a cable that is located between the content source 110 and a selected display 130.

Although in the embodiment of FIG. 2 and FIGS. 3 and 4 below, a CEC line interrupter of the present invention is depicted as a dongle, in alternate embodiments of the present invention, a CEC line interrupter can include a cable having a male and a female HDMI connector in which all wires in the HDMI connector are passed through from Male to Female through the except the CEC line as described above.

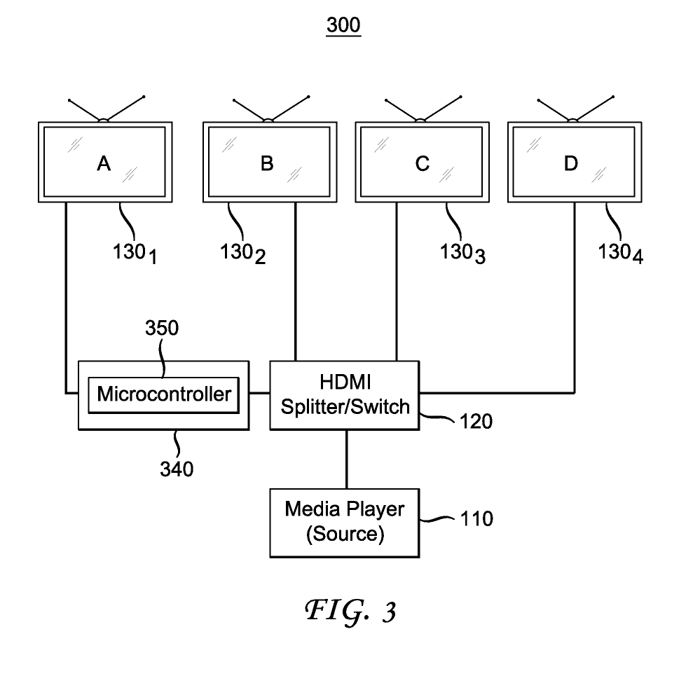

FIG. 3 depicts a high level block diagram of a system, similar to the system of FIG. 2, in which a media player is connected to a plurality of displays via an HDMI splitter/switch and using HDMI communication including an alternate embodiment of a CEC line interrupter in accordance with an alternate embodiment of the present invention. The system 300 of FIG. 3 includes an embodiment of a dongle 340 of the present invention that consists of a male and a female HDMI connector connected together via a small circuit board/microcontroller 350. In the dongle 340 of FIG. 3, all wires in the HDMI connector are passed through from Male to Female except the CEC line. The CEC line is broken and connected on either side through the microcontroller 350. In one embodiment of the present invention, the microcontroller 350 of the dongle 340 of FIG. 3 is configured to selectively block some or all CEC commands. For example, the microcontroller of the dongle 340 of FIG. 3 can be configured to block only broadcast ‘standby’ messages, or all broadcast messages, or only certain message types. The microcontroller can be configured at the factory or in alternate embodiments can be configured using program commands at a user site or via special CEC messages. That is, in various embodiments of the present invention, the dongle 340 is programmable such that a user can selectively block some CEC messages while allowing others to pass through.

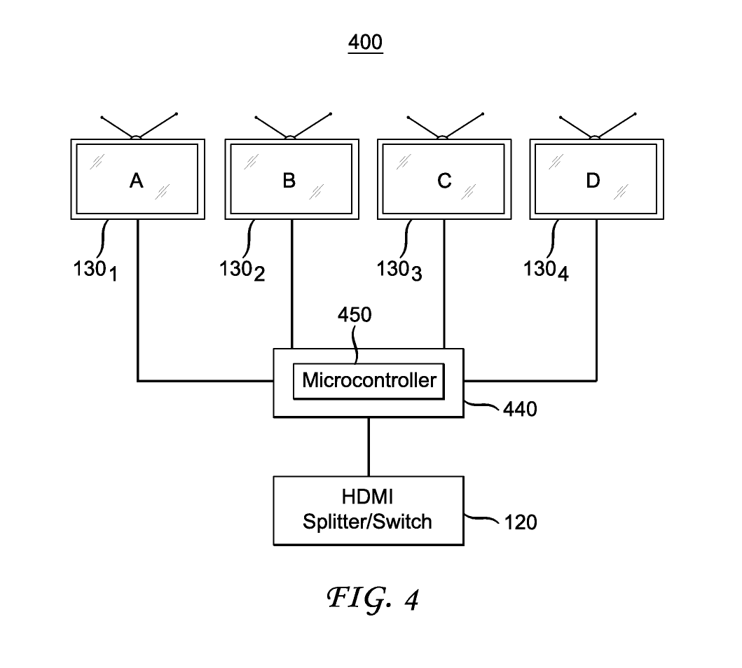

Although in the embodiment of FIG. 3, the dongle 340 is illustratively located on one output of the HDMI splitter/switch 120 in a communication line with the first display 130₁, in alternate embodiments of the present invention, a dongle of the present invention can be located on main output of a HDMI switch such that a microcontroller of the dongle can control the communication of the CEC messages to all included displays. For example, FIG. 4 depicts a high level block diagram of a system, similar to the systems of FIGS. 2 and 3, in which a media player is connected to a plurality of displays via an HDMI splitter/switch and using HDMI communication including an alternate embodiment of a CEC line interrupter in accordance with an alternate embodiment of the present invention.

The system 400 of FIG. 4 includes an embodiment of a CEC line interrupter 440 of the present invention that consists of a male and a female HDMI connector connected together via a small circuit board/microcontroller 450. In the CEC line interrupter 440 of FIG. 4, all wires in the HDMI connector are passed through from Male to Female except the CEC line. The CEC line is broken and connected on either side through the microcontroller 450. In one embodiment of the present invention, the microcontroller 450 of the dongle 440 of FIG. 4 is configured to selectively block some or all CEC commands. The CEC line interrupter 440 of FIG. 4 illustratively comprises four outputs and each output goes to a respective display 130. In the embodiment of FIG. 4, the CEC line interrupter 440 can be configured at the factory or in alternate embodiments can be configured using program commands at a user site or via special CEC messages. That is, in various embodiments of the present invention, the CEC line interrupter 440 is programmable such that a user can selectively block some CEC messages while allowing others to pass through. In the embodiment of FIG. 4, the CEC line interrupter 440 receives HDMI communications, including CEC messages, from the HDMI splitter/switch 120 and the CEC line interrupter 440 is configured to controllably block some CEC messages on any of the output ports while allowing others to pass through on any of the output ports.

In an alternate embodiment of the present invention, the capabilities of the three above described embodiments of the present invention with respect to FIGS. 2, 3 and FIG. 4 can be inclusively or individually integrated into a HDMI splitter/switch (not shown), such as the HDMI splitter/switch 120, in accordance with the concepts of the present invention. Such an embodiment of the present invention provides a means to direct the splitter/switch to ‘open’ the CEC line for a specific output port, or to block some or all CEC commands. For example, such a HDMI splitter/switch including the technical features of a dongle of the present invention can block only broadcast ‘standby’ messages, or all broadcast messages, or only block certain message types on a specific port. The switch of the present invention could be controlled over the input CEC line, a serial port, or a network port. This configuration of selectively blocking CEC commands on output ports could also be done dynamically based on rules in the device and the active reading of a display type using the HDMI EDID capability.

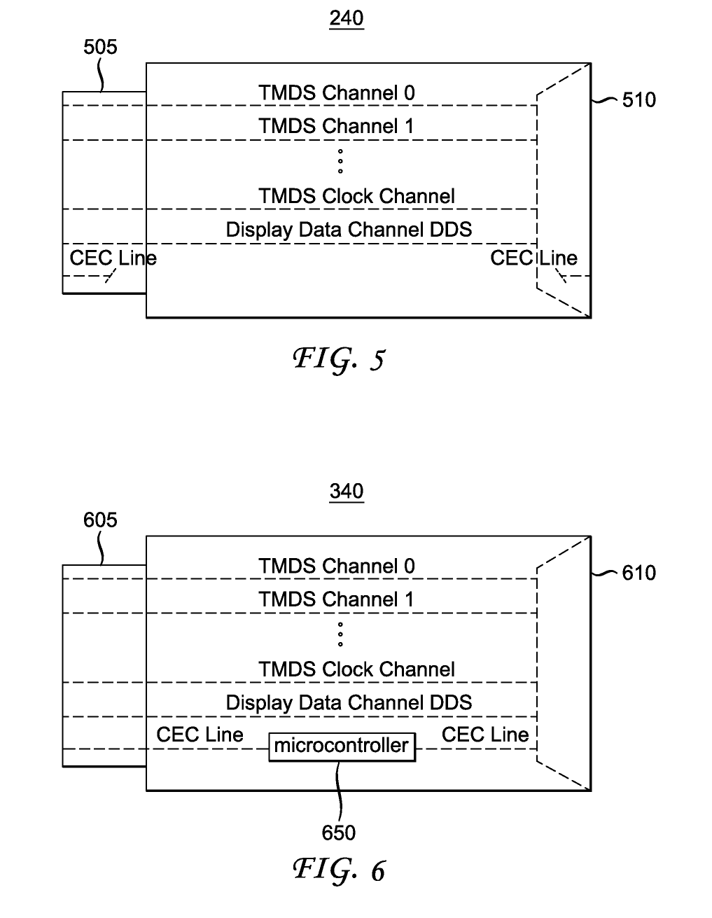

FIG. 5 depicts a high level block diagram of a CEC line interrupter in accordance with an embodiment of the present invention. In the embodiment of FIG. 5 the CEC line interrupter comprises a dongle 240. The dongle 240 of FIG. 5 illustratively includes a male HDMI connector 505 and a female HDMI connector 510. In the embodiment of FIG. 5, all pins in the male HDMI connector 505 are in electrical communication with the Female HDMI connector 510 except the CEC line. The CEC pin of the male HDMI connector 505 is not in electrical communication with the CEC pin of the Female HDMI connector 510. As described above, in one embodiment of the present invention both, the CEC line of the male HDMI connector 505 and the CEC line of the Female HDMI connector 510 are terminated with an appropriate resistor (not shown) as if CEC was not supported at all in an HDMI line connecting a source of HDMI data with a receiver of HDMI data between which an embodiment of a CEC line interrupter of the present invention is connected.

FIG. 6 depicts a high level block diagram of a CEC line interrupter in accordance with an alternate embodiment of the present invention. As depicted in FIG. 5, a CEC line interrupter 340 in accordance with an embodiment of the present invention includes a male HDMI connector 605, a microcontroller 650 and a female HDMI connector 610. In the embodiment of FIG. 6, all pins in the male HDMI connector 605 are in electrical communication with the Female HDMI connector 610 except the CEC line. In the embodiment of FIG. 6, the CEC line of the male HDMI connector 605 and the CEC line of the Female HDMI connector 610 are connected via the microcontroller 650.

In one embodiment of the present invention, the microcontroller 650 of the CEC line interrupter 340 of FIG. 6 is configured to selectively block some or all CEC commands. For example, the microcontroller of the CEC line interrupter 340 of FIG. 6 can be configured to block only broadcast ‘standby’ messages, or all broadcast messages, or only certain message types. The microcontroller 650 can be configured at the factory or in alternate embodiments can be configured using program commands at a user site or via special CEC messages. That is, in various embodiments of the present invention, the CEC line interrupter 340 of FIG. 6 is programmable such that a user can selectively block some CEC messages while allowing others to pass through.

Having described various embodiments for a method and apparatus for providing a selective means to interrupt HDMI CEC broadcast messages (and optionally vendor specific messages) (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method for selectively interrupting high definition multimedia interface (HDMI) consumer electronics control (CEC) broadcast messages, comprising:
identifying at least one CEC line for which communication is to be interrupted; and
inserting, along a connection means including said CEC line between a source of an HDMI CEC broadcast message and a receiver, an apparatus including:
a male HDMI connector; and
a female HDMI connector;
wherein connections of the male HDMI connector are in electrical communication with respective connections of the female HDMI connector to form a pass through connector except for a CEC line of the male HDMI connector and the female HDMI connector, which are not connected.

2. The method of claim 1, further comprising controllably connecting and disconnecting the CEC line of the male HDMI connector and the female HDMI connector.

3. The method of claim 2, wherein said CEC line is controllably connected and disconnected in response to a CEC command.

4. The method of claim 1, wherein said apparatus further comprises a circuit board programmed to block selected CEC commands by controllably connecting and disconnecting a respective CEC line.

5. The method of claim 1, further comprising electrically isolating the respective CEC lines on the side of the male HDMI connector and the side of the female HDMI connector.

6. An apparatus for selectively interrupting HDMI CEC broadcast messages, comprising:
a male HDMI connector; and
a female HDMI connector;
wherein connections of the male HDMI connector are in electrical communication with respective connections of the female HDMI connector to form a pass through connector except for a CEC line of the male HDMI connector and the female HDMI connector, which are not connected.

7. The apparatus of claim 6, wherein the respective CEC lines are electrically isolated on the side of the male HDMI connector and the side of the female HDMI connector.

8. The apparatus of claim 7, wherein the respective CEC lines are terminated with a resistor.

9. The apparatus of claim 6, further comprising a circuit board for controllably connecting and disconnecting the CEC line of the male HDMI connector and the female HDMI connector.

10. The apparatus of claim 9, wherein said apparatus is integrated into an HDMI splitter comprising at least two HDMI outputs, wherein said apparatus is operable for controllably connecting and disconnecting a CEC line of at least one the at least HDMI outputs.

11. An HDMI splitter, comprising:
an HDMI input;
at least two HDMI outputs; and
at least one means for selectively interrupting HDMI CEC broadcast messages to be communicated from the at least two HDMI outputs, said at least one means including:
a male HDMI connector;
a female HDMI connector; and
a circuit board for electrically connecting the connections of the male HDMI connector to the respective connections of the female HDMI connector and for controllably connecting and disconnecting the CEC line of the male HDMI connector and the female HDMI connector.

12. The HDMI splitter of claim 11, wherein the respective CEC lines are electrically isolated on the side of the male HDMI connector and the side of the female HDMI connector.

13. The HDMI splitter of claim 12, wherein the respective CEC lines are terminated with a resistor.

14. The HDMI splitter of claim 11, wherein said CEC line is controllably connected and disconnected in response to a CEC command.
